(19) United States
(12) Patent Application Publication
(10) Pub. No.: US 2008/0094151 A1
(43) Pub. Date: Apr. 24, 2008

(54) Equalization Network For Balanced Cabling

(75) Inventor: Olindo Savi, Berlin, CT (US)

Correspondence Address: CANTOR COLBURN, LLP, 20 Church Street, 22nd Floor, Hartford, CT, 06103, US

(73) Assignee: THE SIEMON COMPANY, Watertown, CT (US)

(21) Appl. No.: 11/845,152

(22) Filed: Aug. 27, 2007

Related U.S. Application Data
(60) Provisional application No. 60/841,013, filed on Aug. 30, 2006.

(51) Int. Cl. H04B 3/04

(52) U.S. Cl. 333/28 R

(57) ABSTRACT

A cable assembly includes a length of balanced cable having at least one twisted pair of wires; a first printed circuit board in electrical connection with a first end of the twisted pair of wires, the first printed circuit board positioned in a first connector for mating with a transmit port on first equipment; a second printed circuit board in electrical connection with a second end of the twisted pair of wires, the second printed circuit board positioned in a second connector for mating with a receive port on second equipment; the second printed circuit board including an equalization network for compensating for transmission loss along the cable from the first end to the second end.

### CROSS REFERENCE TO RELATED APPLICATIONS

This application claims the benefit of U.S. provisional patent application Ser. No. 60/841,013 filed Aug. 30, 2006, the entire contents of which are incorporated herein by reference.

### BACKGROUND

Recent market trends have pointed to a need to support increased data rates (10 Gbps or greater) to support a variety of high speed target applications which include, but are not limited to, server rooms, data centers, server clusters, switch stacking, and switch aggregation. There is a need to develop low cost, higher performing balanced copper communication links to connect this equipment.

### SUMMARY

Embodiments of the invention include a cable assembly comprising a length of balanced cable having at least one twisted pair of wires; a first printed circuit board in electrical connection with a first end of the twisted pair of wires, the first printed circuit board positioned in a first connector for mating with a transmit port on first equipment; a second printed circuit board in electrical connection with a second end of the twisted pair of wires, the second printed circuit board positioned in a second connector for mating with a receive port on second equipment; the second printed circuit board including an equalization network for compensating for transmission loss along the cable from the first end to the second end.

### BRIEF DESCRIPTION OF THE DRAWINGS

FIG. 1 illustrates an exemplary application for an equalization network in embodiments of the invention.

FIG. 2 is a graph of performance versus frequency.

### DETAILED DESCRIPTION

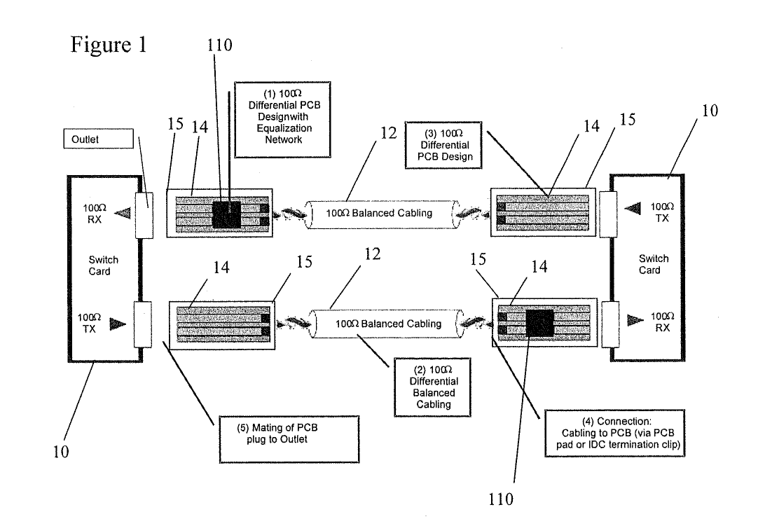

Embodiments include the use of passive and/or active equalization networks applied to connectors or cable assemblies for supporting high speed data communication links. FIG. 1 provides an exemplary application layout for the use of a equalization network within a cable assembly. The system includes switch cards 10 communicating over 100 ohm differential balanced cabling 12. The cabling 12 includes twisted pairs as known in the art. The twisted pair includes a tip wire and a ring wire twisted about each other. It is understood that embodiments of the invention may be used with other equipment. At a transmitter (TX) port and a receiver (RX) port of the switch card 10, a 100 ohm differential PCB 14 is provided to interface with the 100 ohm differential balanced cabling 12.

At the receiver ports (RX) of the switch cards 10, the PCB 14 includes an equalization network 110. The equalization network 110 may use active and/or passive components to adjust for signal losses along cabling 12. In exemplary embodiments, the equalization network 110 includes resistive, inductive and/or capacitive components to equalize the insertion loss across frequencies in the transmission spectrum. The equalization network 110 is placed in-line with given pair. Assuming the cabling 12 includes 4 pairs, a total of four equalization networks would be included within the equalization network 110 (one for each pair). The PCB 14 may be embodied within a plug or other form of connecter 15. Connector 15 mates with transmit and receive ports on the equipment 10. One example of a plug including a PCB is disclosed in U.S. patent application publication 20040116081, the entire contents of which are incorporated herein by reference. The equalization network 110 is applied to one end of the cable assembly. The overall cable assembly would be constructed using 100 ohm cables (of a given length) terminated to two plugs (e.g., TERA brand plugs available form The Siemon Company). The resultant cable assembly is then mated between two high-speed switch cards 10 at outlets.

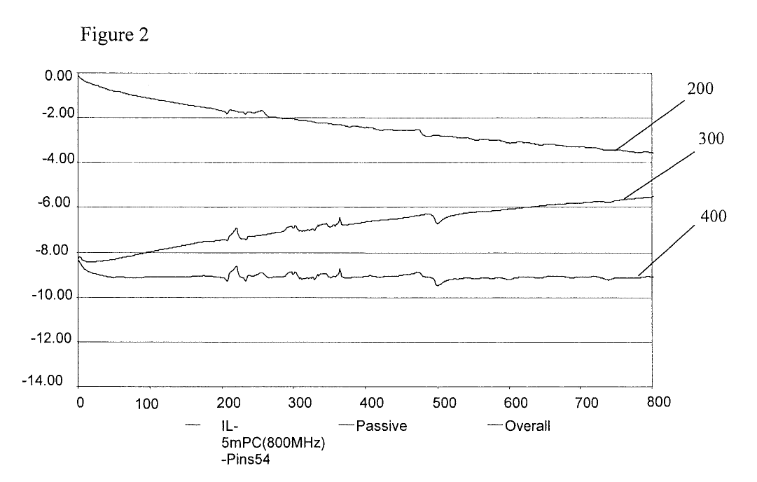

FIG. 2 is a plot of losses versus frequency for representative measurement data for typical losses incurred in a 5 m cable assembly. The trace 200 provides the Sdd21 (input differential insertion loss) insertion loss of the 5 m cable assembly. The trace 300 provides the Sdd21 insertion loss of the equalization network 110. The trace 400 provides the overall resultant loss. A passive equalization network 110, when combined with the loss of the cabling 12, generates a flat spectrum of input differential insertion loss as denoted by the trace 400. This example provides measurement data up to 800 MHz. Although the amplitude of the resultant trace 400 is less than the signal amplitude unfiltered (trace 200), signal integrity (e.g., quality of the digital shape) is better maintained for a flat spectrum. An active equalization network 110 provides a similar flat spectrum shape, however, the overall resultant trace would display gain rather than loss. In other words, if active components are used in the equalization network 110, gain may be applied to increase amplitude to equal or higher than that of trace 200.

The equalizer networks 110 provide a means of creating a filter response to compensate for transmission medium losses associated with the PCB, connector, and cables. In exemplary embodiments, the equalization network includes a filter circuit comprised of either active or passive components designed such that interstage reflection coefficients are minimized achieving controlled impedance behavior over the frequency band. The equalization networks 110 provide a means to increase transmission distances (for a given data rate) and/or data rates (for a given length) for high-speed communications links.

Benefits of embodiments of the invention include a lower manufacturing cost compared to other high-speed link alternatives. The equalization networks 110 provide a means of compensating for high frequency losses introduced by PCB, connectors, or cabling. One benefit is a level transmission loss spectrum over a given frequency band, shown in trace 400, resulting in minimizing jitter impairments. Additional benefits (as compared to high-speed alternatives) include increased distances for a given rate, ability to support bi-directional traffic signaling, crosstalk reduction, and lower cabling losses.

While the invention has been described with reference to exemplary embodiments, it will be understood by those skilled in the art that various changes may be made and equivalents may be substituted for elements thereof without departing from the scope of the invention. In addition, many modifications may be made to adapt to a particular situation or material to the teachings of the invention without departing from the essential scope thereof. Therefore, it is intended that the invention not be limited to the particular embodiments disclosed for carrying out this invention.

What is claimed is:

1. A cable assembly comprising:
a length of balanced cable having at least one twisted pair of wires;
a first printed circuit board in electrical connection with a first end of the twisted pair of wires, the first printed circuit board positioned in a first connector for mating with a transmit port on first equipment;
a second printed circuit board in electrical connection with a second end of the twisted pair of wires, the second printed circuit board positioned in a second connector for mating with a receive port on second equipment;
the second printed circuit board including an equalization network for compensating for transmission loss along the cable from the first end to the second end.

2. The cable assembly of claim 1 wherein:
the cable has four pairs;
the second printed circuit board having an equalization network for each pair.

3. The cable assembly of claim 1 wherein the equalization network includes passive components.

4. The cable assembly of claim 3 wherein the passive components include at least two of resistive, inductive and capacitive components.

5. The cable assembly of claim 1 wherein the equalization network includes active components.

6. The cable assembly of claim 1 wherein transmission loss is insertion loss.

7. The cable assembly of claim 6 wherein the insertion loss is input differential insertion loss.

8. The cable assembly of claim 1 wherein compensating for transmission loss includes adjusting the transmission loss along the cable to achieve a flat transmission loss spectrum across a transmission frequency band.
